(19) United States
(12) Patent Application Publication
(10) Pub. No.: US 2017/0164109 A1
(43) Pub. Date: Jun. 8, 2017

(54) SPEAKER ARRANGEMENT

(71) Applicant: Marcus Lewis, Ross-on-Wye, Herefordshire (GB)

(72) Inventor: Marcus Lewis, Ross-on-Wye, Herefordshire (GB)

(21) Appl. No.: 15/327,182

(22) PCT Filed: Jul. 16, 2015
(86) PCT No.: PCT/GB2015/052066

§ 371 Date: Jan. 18, 2017

(30) Foreign Application Priority Data
Jul. 18, 2014 (GB) 1412772.4

(51) Int. Cl. H04R 3/12; H04R 5/04; H04S 5/00; H04R 5/02

(52) U.S. Cl. CPC H04R 3/12; H04R 5/02; H04R 5/04; H04S 5/005; H04R 2205/021; H04R 2420/07

(57) ABSTRACT

A speaker arrangement including a housing adapted to receive an input from a source device, the housing having a first transmitter of a first wireless communications link and a second transmitter of a second wireless communications link, and a controller operable such that the received signal is split into a first output signal for transmission by the first transmitter and a second output signal for transmission by the second transmitter.

This invention relates to a speaker arrangement, and in particular to a speaker arrangement allowing a user to listen to, for example, digitally stored music. It will be appreciated, however, that the equipment may be used for other purposes. The invention relates, in particular, to a surround sound speaker arrangement whereby a user's listening experienced can be enhanced.

A number of personal audio equipment devices are known. Typically such devices include a source such as an mp3 file player, a mobile telephone device or the like adapted to output a signal to the speakers of a set of headphones or earpieces. The connection between the source and the headphones has traditionally been by way of a wired connection. However, such an arrangement is often inconvenient as the wired connection between the source and the headphones may become tangled with other objects or may place constraints on the locations in which the user may store the source device. Furthermore, the wired connection may be obtrusive, and hence undesirable.

There is a desire to provide speaker arrangements suitable for use with such devices, to enhance the user's listening experience, and to allow the output to be heard by more than one user at a time.

Surround sound speaker arrangements are well known and are in common usage. However, such speaker arrangements typically make use of relatively large speakers connected to one another and to a music source via electrical cables. As a consequence, the known speaker arrangements are not portable, and tend to be relatively complex to install.

Wireless speakers, for example for use with mobile telephones and the like, to which signals are transmitted by way of a microwave communications link such as a Bluetooth link are also known. However, the speakers are typically of relatively poor quality. Furthermore, there are limits to the number of speakers with which the source is able to communicate with the result that the provision of a good quality surround sound listening experience has not been possible.

It is an object of the invention to provide a speaker arrangement allowing greater flexibility over the use and output thereof, and whereby the user's listening experience can be enhanced.

According to one aspect of the invention there is provided a speaker arrangement comprising a housing adapted to receive an input from a source device, the housing having a first transmitter of a first wireless communications link and a second transmitter of a second wireless communications link, and a controller operable such that the received signal is split into a first output signal for transmission by the first transmitter and a second output signal for transmission by the second transmitter.

The source device may be connected via a wired link to the housing, for example via a 3.5 mm jack and socket arrangement. However, this need not be the case and other arrangements including wireless arrangements are possible. Furthermore, the source device could be incorporated into the housing.

The source device conveniently comprises a mobile telephone device, preferably a smart phone, capable of playing audio data files. However, the invention is not restricted in this regard and the source device may take a range of other forms such as a dedicated mp3 player device.

The first and second transmitters may, in one arrangement, comprise mono transmitters. In such an arrangement, the controller may be operable to split the received signal into a left channel signal forming the first output signal for transmission by the first transmitter and a right channel signal forming the second output signal for transmission by the second transmitter.

The speaker arrangement conveniently further comprises a first speaker including a first receiver operable to receive the signal transmitted by the first transmitter, and a second speaker including a second receiver operable to receive the signal transmitted by the second transmitter. Each speaker is operable to output a sound signal corresponding with the associated received signal.

It will be appreciated that such an arrangement allows a user to experience a stereo output, the output being produced from a pair of speakers located remotely of the source.

In a second arrangement, two (or more) speakers, each having a stereo receiver, may be arranged to receive the output from the first transmitter, and similarly two (or more) speakers may receive the signal from the second transmitter. As the transmitters are mono transmitters, the stereo receivers will not attempt to unlace the received signal. Both speakers receiving the first signal will output the same sound signal, and both speakers receiving the second signal will output the same sound signal as one another. Such an arrangement provides the user with an enhanced surround sound effect.

In another arrangement, each transmitter may comprise a stereo transmitter. The first stereo transmitter receives, say, the left channel and transmits that as a first left and a second left signal to respective speakers, and the second transmitter receives the right channel and transmits it as first and second right signals to respective speakers. The controller may be operable, if desired, to modify the input signals to the transmitters such that the stereo signal transmitted by the first transmitter differs from that transmitted by the second transmitter. Depending upon the nature of the input signal and the manner in which the signal is processed, the four speakers may all output different sound signals resulting in the user experiencing a quadrophonic, surround sound experience.

The housing may incorporate one or more additional speakers, for example it may incorporate a woofer and/or tweeter speaker.

Advantageously, the channels of the first transmitter transmit different signals to one another. For example, one channel of the first transmitter may be used to transmit a balanced signal and the other channel used to transmit a bass signal. Similarly, the channels of the second transmitter may be arranged to transmit, respectively, a balanced signal and a treble signal. Accordingly, a user may be able to listen to an enhanced stereo signal whereby the treble and bass signals are played through speakers specifically designed for playback of the corresponding frequency ranges.

Conveniently, the equipment is operable to allow a user to control the frequencies supplied to each of the speakers, and/or to control the volume of the signals supplied to the speakers. As a result, the user's experience is further enhanced. The manner in which this is achieved may be by way of an application or program operating on the source device. By way of example, the application may process each channel of a stereo audio signal and modify it such that the signal supplied to the input consists of short segments of signal intended for the first and third speakers alternating with short segments intended for the second and fourth speakers. The segments are preferably of the order of nanoseconds in duration. Before supplying the signals to the input, the application or program allows adjustment of the relative volumes thereof and permits filtering thereof to achieve a desired audio effect. It will be appreciated that the controller, on receipt of such signals and once synchronized to the operation of the source device, can produce appropriate signals for transmission by the transmitters.

The transmitters conveniently transmit on different frequencies to one another and are preferably pre-paired with the receivers of the speaker, thereby avoiding having to repeatedly re-latch the transmitters and receivers to one another.

The invention will further be described, by way of example, with reference to the accompanying drawings, in which:

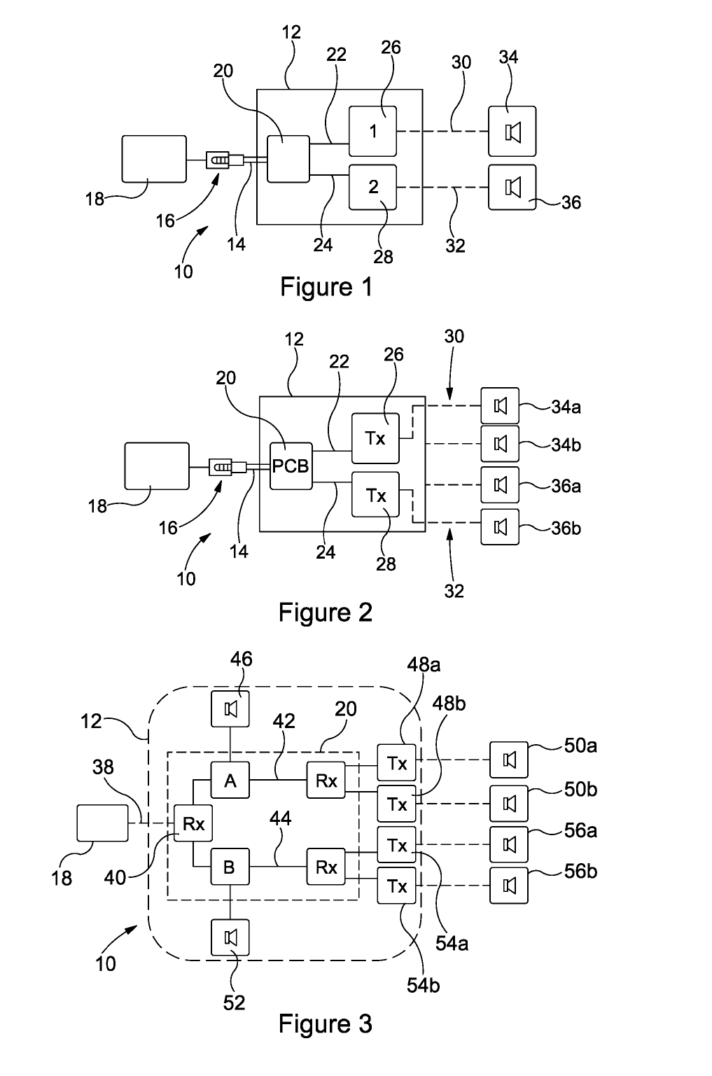

FIGS. 1 to 4 are diagrams illustrating speaker arrangements in accordance with embodiments of the invention;

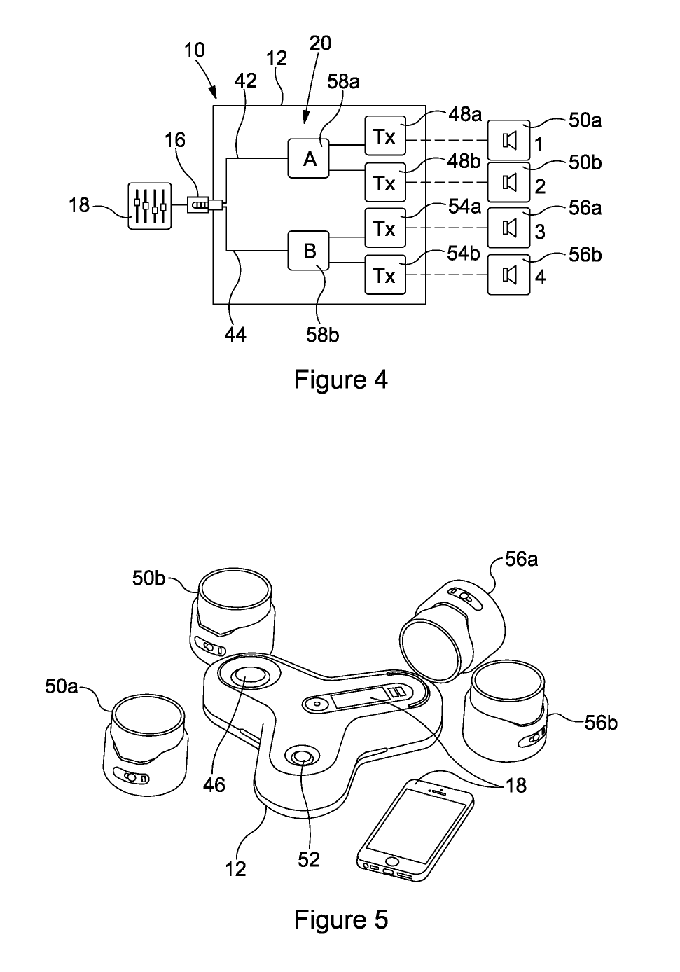

FIG. 5 illustrates a speaker arrangement in accordance with the embodiment of FIG. 4; and

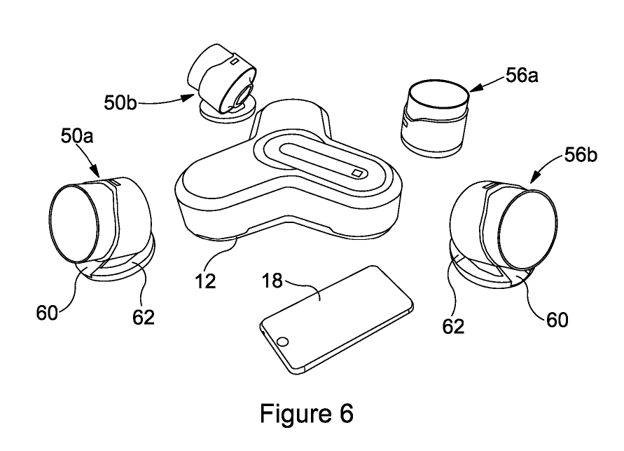

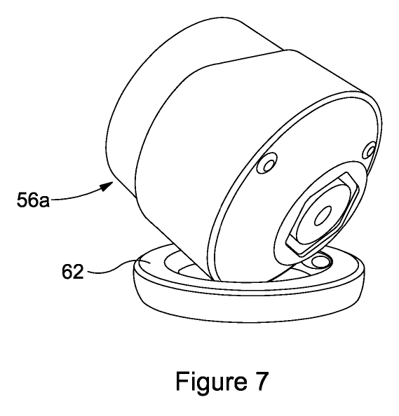

FIGS. 6 and 7 illustrate an arrangement similar to that of FIG. 5.

Referring firstly to FIG. 1, a speaker arrangement 10 is illustrated comprising a housing 12. The housing 12 includes an input cable 14 for connection via a 3.5 mm jack plug and socket arrangement 16 to a source device 18, in this case in the form of a smart phone. If desired, the housing 12 may be shaped so as to form a mount for the source device 16. In use, therefore, a sound signal may be output from the source device 18 to the input cable 14 of the speaker arrangement 10.

Within the housing 12 is located a controller 20 operable to divide the received signal into a left channel 22 and a right channel 24 for onward transmission by first and second mono transmitters 26, 28 forming parts of respective wireless communications links 30, 32 to respective speakers 34, 36. Each speaker 34, 36 includes a respective mono receiver. Each receiver is linked or latched to the respective transmitter 26, 28.

It will be appreciated that such an arrangement allows a user to listen to music or other outputs from the source device 18 via external speakers. The output is a stereo output. As the speakers are wirelessly connected to the source device 18, it will be appreciated that the speaker arrangement is simple to install or set up, and so may be installed quickly and/or temporarily when desired. Despite this simplicity, the listening experience is significantly enhanced. The arrangement makes use of simple, low cost mono transmitters and receivers. Conveniently, the transmitters and receivers are arranged to operate at fixed frequencies, thereby avoiding the need to latch the receivers and transmitters to one another, in use, and avoiding the risk of the receivers becoming latched to the incorrect ones of the transmitters.

FIG. 2 illustrates a slightly more complex arrangement in which instead of having a single speaker 34, 36 latched to each transmitter 26, 28, a pair of speakers 34a, 34b, each including a stereo receiver, is latched to the first transmitter 26, and a pair of speakers 36a, 36b each including a stereo receiver, is latched to the second transmitter 28. As each stereo receiver is receiving just a mono signal, no attempt is made to unlace the signal, and so the speakers 34a, 34b will produce the same output as one another, and the speakers 36a, 36b will produce the same output as one another.

With the speakers positioned around the user, it will be appreciated that the user experiences an enhanced, surround sound experience.

FIG. 3 illustrates a more complex arrangement. In this arrangement, rather than use a wired connection between the source 18 and the housing 12, a wireless link 38 is used, a stereo receiver 40 being provided to receive the transmitted stereo signal from the device 18. The stereo receiver splits the received signal into left and right channels 42, 44. The left channel signal 42 is supplied to a woofer speaker 46 built into the housing 12, and is also supplied to mono transmitters 48a, 48b transmitting to respective remote speakers 50a, 50b. The right channel signal 44 is supplied to a tweeter speaker 52 built into the housing 12, and to mono transmitters 54a, 54b transmitting to respective remote speakers 56a, 56b.

The arrangement of FIG. 3 may be modified by processing of the signals to be supplied to each of the speakers. By way of example, as shown in FIGS. 4 and 5, the source device 18 may be running software whereby the output signal therefrom is modified before being passed to the speaker arrangement 10 (in this case connected by a wired connection).

By way of example, the software may be operable such that the left hand channel signal 42 output therefrom may be modified such that it consists of a series of short segments comprising packets of data intended for output by the speaker 50a, alternating with short segments comprising packets of data intended for output by the speaker 50b. Each segment is conveniently of duration of the order of nanoseconds. Similarly, the right hand channel signal 44 may be modified such that it consists of a series of short segments comprising packets of data intended for output by the speaker 56a, alternating with short segments comprising packets of data intended for output by the speaker 56b. The left and right hand channels made up of the aforementioned data packet segments will, if listened to directly, for example by plugging an earpiece directly into the source device 18, be considerably distorted. User controllable bandpass filters may be provided to allow the user to control the frequency ranges supplied to each speaker, or to certain of the speakers, and/or to control the volume of the signal applied to the various speakers.

Before transmission by the transmitters 48a, 48b, 54a, 54b, processors such as pick processors 58a, 58b which are synchronized to the operation of the application are used to divide each of the left and right hand channel signals into two, and reconstitute the signals from the data packets, so that the left hand channel signal is divided and reconstituted into a first left hand channel signal intended for output by the associated speaker 50a and a second left hand channel signal intended for output by the associated speaker 50b. Likewise the right hand channel signal is divided and reconstituted into a first right hand channel signal intended for output by the associated speaker 56a and a second right hand channel signal intended for output by the associated speaker 56b. In each case, the division of the signals is achieved by separation of the aforementioned segments.

After division of the signals in this manner, the left hand signals are transmitted by the transmitters 48a, 48b, and the right hand signals are transmitted by the transmitters 54a, 54b, for reception by the receivers associated with the speakers and output thereby in substantially the manner described above.

It will be appreciated that when operating in this mode, a user can control the frequencies and volumes output by each speaker, independently of one another, providing a quadrophonic output, the user thus experiencing an enhanced output quality and having enhanced control over the output.

In order to ensure that the user's listening experience is enhanced, it is desirable, in each of the arrangements described hereinbefore, to ensure that the outputs of the speakers are correctly synchronized to one another. In order to achieve this, it may be desired to incorporate delay lines into the controllers or processors thereof so that the onward transmission of appropriate parts of the signals are delayed to bring all of the channels into good synchronization with one another. The delay lines may be incorporated into a balancing circuit adapted to balance the signals between high and low frequency cut-offs. This may be especially important in arrangements of the type shown in FIG. 3 in which certain of the speakers are wired to the housing, others receiving signals via wireless communications links. It has been found that a 500 ms or the like delay line, delaying the output of signals to the wired speakers such as the speaker 46 may be required in order to achieve synchronicity between the outputs of all of the speakers.

Whilst the embodiment described above only incorporates two left channels and two rights channels, it will be appreciated that more than this may be provided, the limiting factor being the point at which the human ear can detect losses in sound quality resulting from the data processing.

Although described hereinbefore as running within the source device 18, it will be appreciated that the processing software may alternatively be run from within the housing 12, if desired.

The housing 12 may be designed in such a manner as to allow the speakers 50a, 50b, 56a, 56b to be stored therein when the system is not in use or is being transported. If desired, when stowed, the speakers may be electrically connected to circuits provided within the housing 12. As a result, if the speakers are powered by rechargeable batteries, charging of the speakers may take place whilst they are stowed, provided the housing 12 has a sufficient power supply to effect such charging.

The speakers, when stowed, are conveniently attached to the underside of the top of the housing 12 by means of a hexagonal undercut protrusion on the underside of the housing 12 that mates with a similar size hexagonal opening of feature (see FIG. 7) formed in the centre of the base of each speaker. When correctly positioned, the speaker is partially twisted clock wise to lock the speaker to the housing 12.

As mentioned hereinbefore, the speakers are conveniently charged whilst stowed within the housing, and the hexagonal feature may include a socket arranged to receive a plug built into the housing, when stowed, for this purpose. The arrangement may include suitable transformers to ensure that a desired DC supplied is applied to each speaker during charging.

Each speaker conveniently has an elastomeric material housing or covering, and the inherent slight cushioning and molecular memory spring provided by this material ensures that the speakers are a snug and tight fit within the housing, when locked in place, without causing frictional damage or unnecessary wear as would be the case were there hard plastic bearing against hard plastic. The elastomeric jackets around each speaker also allow for a firm and positive grip when each unit is locked into place.

FIGS. 6 and 7 illustrate an alternative to the arrangement of FIG. 5 which operates in substantially the manner set out hereinbefore. As shown in FIGS. 6 and 7, each speaker incorporates a hinge 60 whereby a stand 62 is hingedly connected, the hinge 60 allowing the speaker to be moved to an orientation in which it sits upon the stand 62 in an angled orientation.

Whilst the source is described hereinbefore as comprising, for example, a cell phone, mp3 player or the like adapted to play a conventional audio file, the system could also be used in the simultaneous output of separate recordings to different speakers, or combinations of the speakers. By way of example, different instruments or parts may be output to different ones of the speakers. If the parts relate to, say, sections of an orchestra, then certain of the speakers may be used to output only or primarily the strings section, and others of the speakers may be used to output only or primarily the brass section, etc. It will be appreciated, however, that the arrangement may be used in other applications. Where the number of parts is greater than the number of speakers, then the arrangement conveniently controls the outputs to combine certain of the parts.

It will be appreciated that whilst the description hereinbefore is of specific examples of the invention, a number of modifications and alterations may be made thereto without departing from the scope of the invention.

1. A speaker arrangement comprising a housing adapted to receive an input signal from a source device, the housing having a first transmitter of a first wireless communications link and a second transmitter of a second wireless communications link, and a controller operable such that the received input signal is split into a first output signal for transmission by the first transmitter and a second output signal for transmission by the second transmitter.

2. An arrangement according to claim 1, wherein the source device is connected via a wired link to the housing.

3. An arrangement according to claim 1, wherein the source device is connected via a wireless link to the housing.

4. An arrangement according to claim 1, wherein the source device is incorporated into the housing.

5. An arrangement according to claim 1, wherein the source device comprises at least one of a mobile telephone device, a smart phone, a device capable of playing audio data files, a laptop computer, and an mp3 player device.

6. An arrangement according to claim 1, wherein the first and second transmitters comprise mono transmitters.

7. An arrangement according to claim 6, wherein the controller is operable to split the received signal into a left channel signal forming the first output signal for transmission by the first transmitter and a right channel signal forming the second output signal for transmission by the second transmitter.

8. An arrangement according to claim 1, wherein the speaker arrangement further comprises a first speaker including a first receiver operable to receive the signal transmitted by the first transmitter, and a second speaker including a second receiver operable to receive the signal transmitted by the second transmitter.

9. An arrangement according to claim 8, wherein each speaker is operable to output a sound signal corresponding with the associated received signal.

10. An arrangement according to claim 6, and including at least two speakers, each having a stereo receiver, arranged to receive the output from the first transmitter, and at least two speakers receiving the signal from the second transmitter.

11. An arrangement according to claim 1, wherein each transmitter comprises a stereo transmitter.

12. An arrangement according to claim 11, wherein the controller is operable to modify the input signals to the transmitters such that the stereo signal transmitted by the first transmitter differs from that transmitted by the second transmitter.

13. An arrangement according to claim 12, and operable to allow a user to control the frequencies supplied to each of the speakers, and/or to control the volume of the signals supplied to the speakers.

14. An arrangement according to claim 13, wherein the control is effected using an application or program.

15. An arrangement according to claim 14, wherein the application processes each channel of a stereo audio signal and modifies it such that the signal supplied to the input consists of short segments of signal intended for first and third ones of the speakers alternating with short segments intended for second and fourth ones of the speakers.

16. An arrangement according to claim 15, wherein the segments are of the order of nanoseconds in duration.

17. An arrangement according to claim 15 wherein before supplying the signals to the input, the application or program allows adjustment of the relative volumes thereof and permits filtering thereof to achieve a desired audio effect.

18. An arrangement according to claim 15 wherein the controller, on receipt of such signals and once synchronized to the operation of the source device, produces appropriate signals for transmission by the transmitters.
